(19) United States
(12) Patent Application Publication
(10) Pub. No.: US 2008/0115982 A1
(43) Pub. Date: May 22, 2008

(54) Auxiliary power device for a wheelchair

(75) Inventor: Tsung-Yi Lin, Tainan Hsien (TW)

Correspondence Address: DLA PIPER US LLP, 2000 UNIVERSITY AVENUE, E. PALO ALTO, CA, 94303-2248, US

(73) Assignee: ZMI Electronics Ltd.

(21) Appl. No.: 11/600,512

(22) Filed: Nov. 16, 2006

(51) Int. Cl. A61G 5/04

(52) U.S. Cl. 180/13

(57) ABSTRACT

An auxiliary power device for a wheelchair includes a coupling seat unit disposed on the chair frame, an adjustable unit, and a power supply unit. The adjustable unit includes a steering operation rod unit disposed rotatably on the coupling seat unit, an electrical wheel unit disposed on a bottom end of the operation rod unit, and a linkage interconnecting the electrical wheel unit and the coupling seat unit. The power supply unit provides electricity to the electrical wheel unit. The electrical wheel unit is movable relative to the operation rod unit between a used position whereat a lower end of the electrical wheel unit is below that of the front wheels, and an unused position whereat the lower end of the electrical wheel unit is above that of the front wheels.

### BACKGROUND OF THE INVENTION

1. Field of the Invention

This invention relates to wheelchairs, and more particularly to an auxiliary power device for a wheelchair.

2. Description of the Related Art

Various auxiliary power devices have been widely used in hand-operated wheelchairs. However, a conventional auxiliary power device is bulky, and typically has a steering operation rod, which is not foldable or retractable, thereby resulting in difficulties when the user gets on and off the wheelchair.

### SUMMARY OF THE INVENTION

An object of this invention is to provide a compact auxiliary power device for a wheelchair. Another object of this invention is to provide an auxiliary power device, which can be folded easily so as to allow the user to conveniently get on and off the wheelchair.

According to this invention, an auxiliary power device for a wheelchair includes a coupling seat unit disposed on the chair frame, an adjustable unit, and a power supply unit. The adjustable unit includes a steering operation rod unit disposed rotatably on the coupling seat unit, an electrical wheel unit disposed on a bottom end of the operation rod unit, and a linkage interconnecting the electrical wheel unit and the coupling seat unit. The power supply unit provides electricity to the electrical wheel unit. The electrical wheel unit is movable relative to the operation rod unit between a used position whereat a lower end of the electrical wheel unit is below that of the front wheels, and an unused position whereat the lower end of the electrical wheel unit is above that of the front wheels. As such, the auxiliary power device may be selectively used and has a compact structure.

The operation rod unit is foldable or retractable. Thus, the user can conveniently get on and off the wheelchair.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a wheelchair including the first preferred embodiment of an auxiliary power device according to this invention;

FIG. 2 is an assembled perspective view of the first preferred embodiment;

FIG. 3 is an exploded perspective view of the first preferred embodiment;

FIG. 4 is a fragmentary, partly sectional front view of the first preferred embodiment;

FIG. 5 is a side view of the first preferred embodiment when an electrical wheel unit is disposed in an unused position;

FIG. 6 is a side view of the first preferred embodiment when the electrical wheel unit is disposed in a used position;

FIG. 7 is an assembled perspective view of a wheelchair including the second preferred embodiment of an auxiliary power device according to this invention;

FIG. 8 is an exploded perspective view of the second preferred embodiment;

FIG. 9 is a partly sectional view of the second preferred embodiment, illustrating how a sliding block is positioned on a mounting seat;

FIG. 10 is a perspective view illustrating a modification to a steering operation rod unit of the second preferred embodiment;

FIG. 11 is a side view of the second preferred embodiment when an electrical wheel unit is disposed in an unused position;

FIG. 12 is a side view of the second preferred embodiment when the electrical wheel unit is disposed in a used position;

FIG. 13 is a side view of the third preferred embodiment of an auxiliary power device when an electrical wheel unit is disposed in an unused position; and

FIG. 14 is a side view of the third preferred embodiment when the electrical wheel unit is disposed in a used position.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

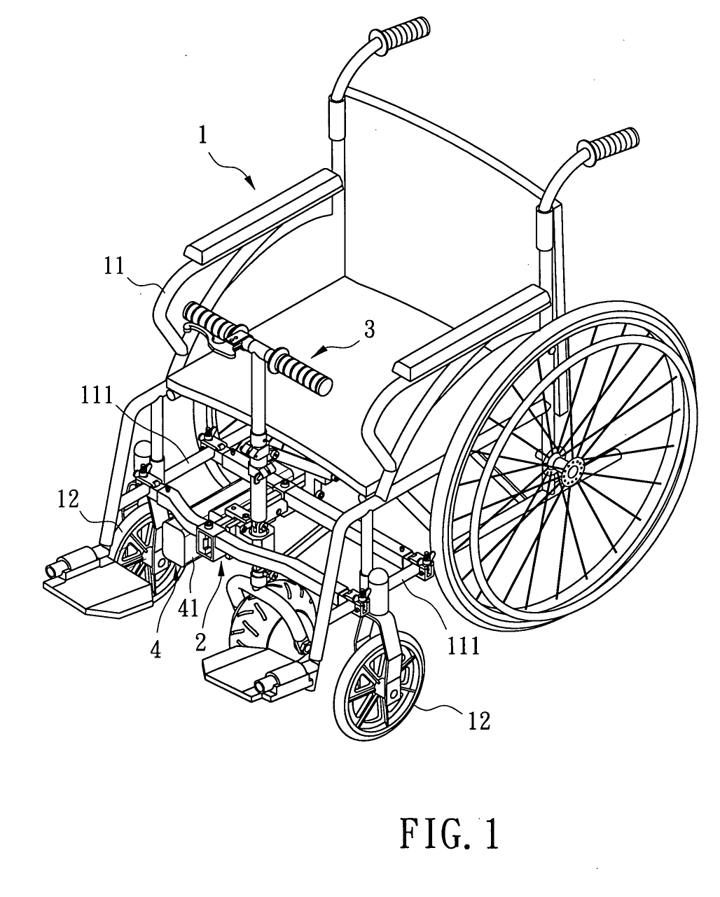

Referring to FIG. 1, the first preferred embodiment of an auxiliary power device according to this invention is suitable for use with a hand-operated wheelchair 1. The wheelchair 1 has a chair frame 11 and two spaced-apart front wheels 12. The chair frame 11 has a pair of left and right side rods 111. The front wheels 12 are disposed respectively and pivotally on front ends of the left and right side rods 111. As such, the front wheels 12 are disposed on a bottom portion of a front end of the chair frame 11.

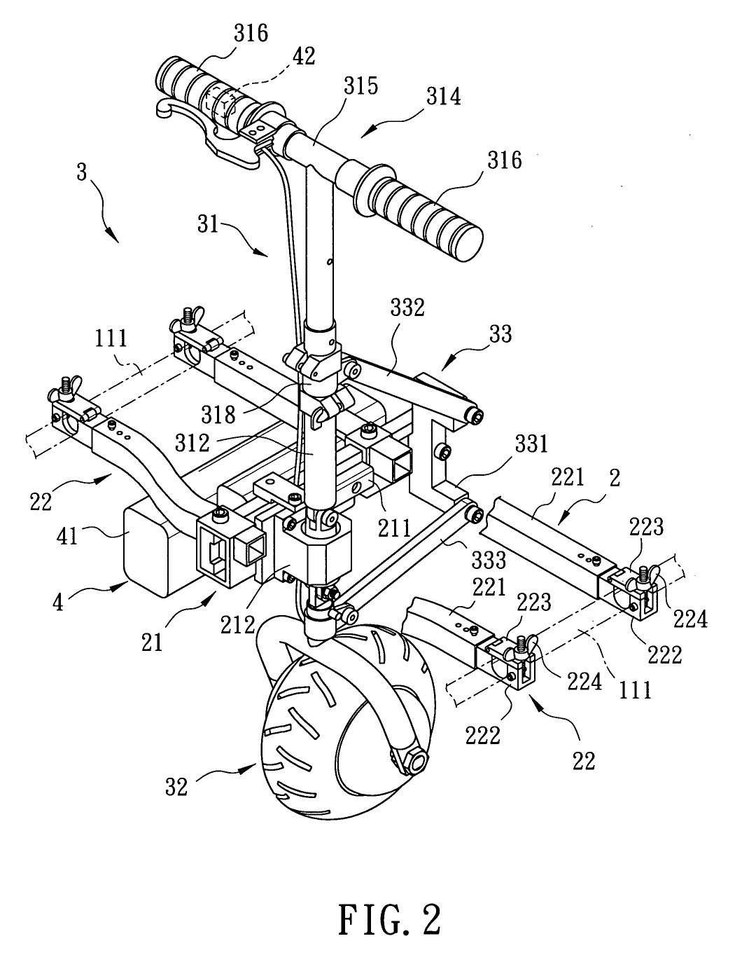

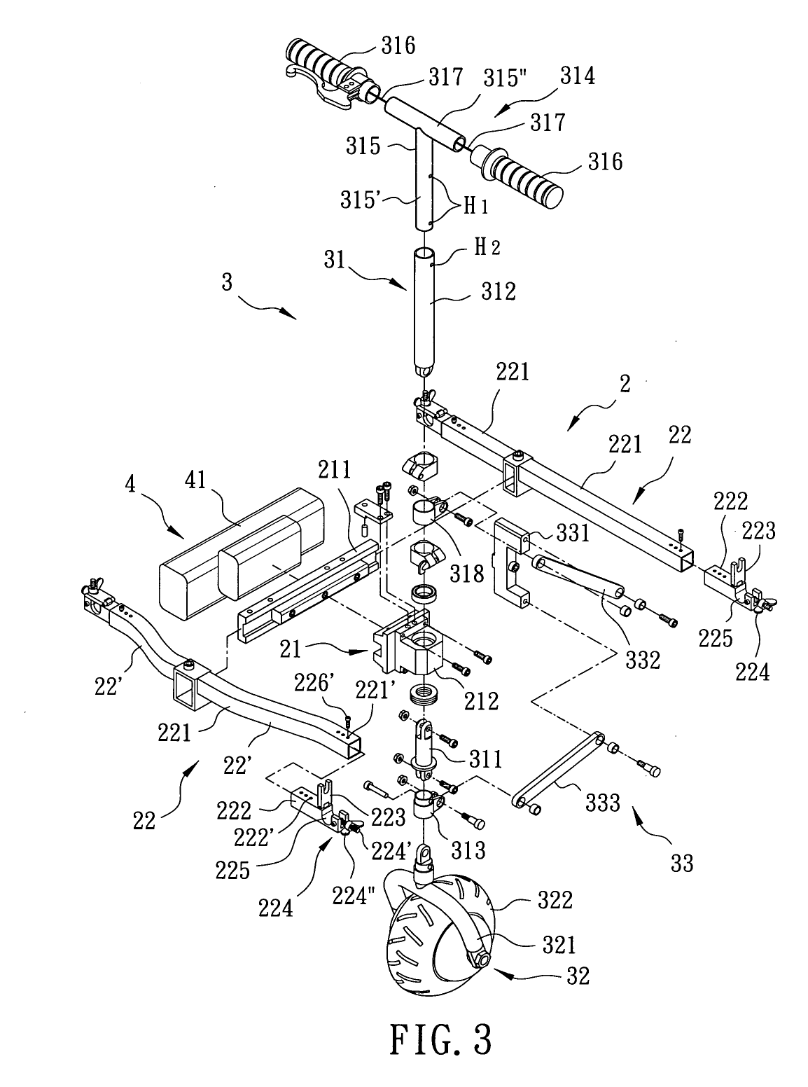

With further reference to FIGS. 2 and 3, the first preferred embodiment includes a coupling assembly 2, an adjustable unit 3, and a power supply unit 4.

The coupling assembly 2 includes a coupling seat unit 21 disposed in front of the chair frame 11 between the left and right side rods 111, and two horizontal rod units 22 connected respectively to two opposite sides of the coupling seat unit 21 and connected respectively and fixedly to front and rear sides of the chair frame 11. The coupling seat unit 21 includes a guide rail 211 disposed between the horizontal rod units 22 and having front and rear ends connected respectively and fixedly to the horizontal rod units 22, and a sliding seat 212 movable along the guide rail 211.

Each of the horizontal rod units 22 includes a pair of telescopic tube members 22′ (see FIG. 3) located respectively to two sides of the guide rail 211. Each of the telescopic tube members 22′ includes an outer tube 221, an inner tube 222, a retaining member 223, and a locking member 224. Since the telescopic tube members 22′ are similar in construction, only one will be described in the succeeding paragraph.

The outer tube 221 has an inner end connected fixedly to the guide rail 211. The inner tube 222 is disposed telescopically within an outer end of the outer tube 221, and has a top surface formed with a slot 225 that has open front and rear ends and that receives a corresponding one of the left and right side rods 111 of the chair frame 11. The retaining member 223 is disposed pivotally on the inner tube 222 and immediately above the slot 225 in the inner tube 222 so as to confine the corresponding one of the left and right side rods 111 between the inner tube 222 and the retaining member 223. The locking member 224 is disposed pivotally on the inner tube 222, and is connected to the retaining member 223 so as to lock the retaining member 223 on the inner tube 222. The locking member 224 includes a threaded rod 224′ (see FIG. 3) connected pivotally to the inner tube 222, and a butterfly nut 224″ (see FIG. 3) engaging the threaded rod 224′. Each of the inner and outer tubes 222, 221 is formed with a plurality of positioning holes 222′, 221′. A positioning pin 226′ extends through a selected one of the positioning holes 221′ in the outer tube 221 and a selected one of the positioning holes 222′ in the inner tube 222. As such, a relative position between the inner and outer tubes 222, 221 can be adjusted. Although the distance between the left and right side rods 111 of the chair frame 11 of the hand-operated wheelchair 1 is not standardized, since the length of each of the horizontal rod units 22 is adjustable, the coupling assembly 2 is suitable for use with any currently available hand-operated wheelchair.

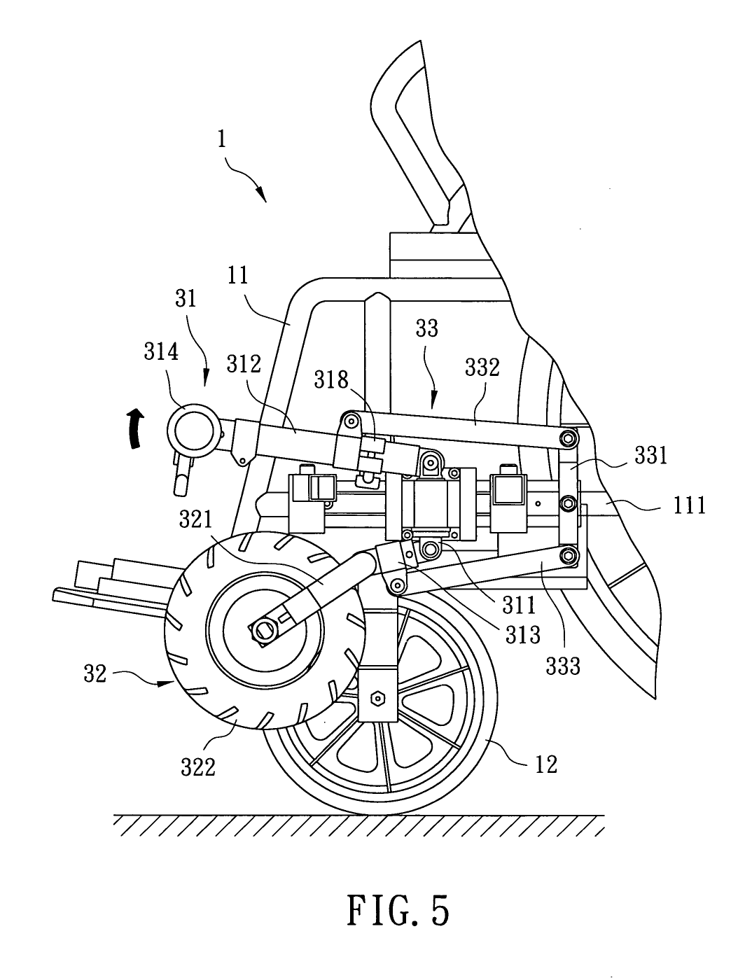

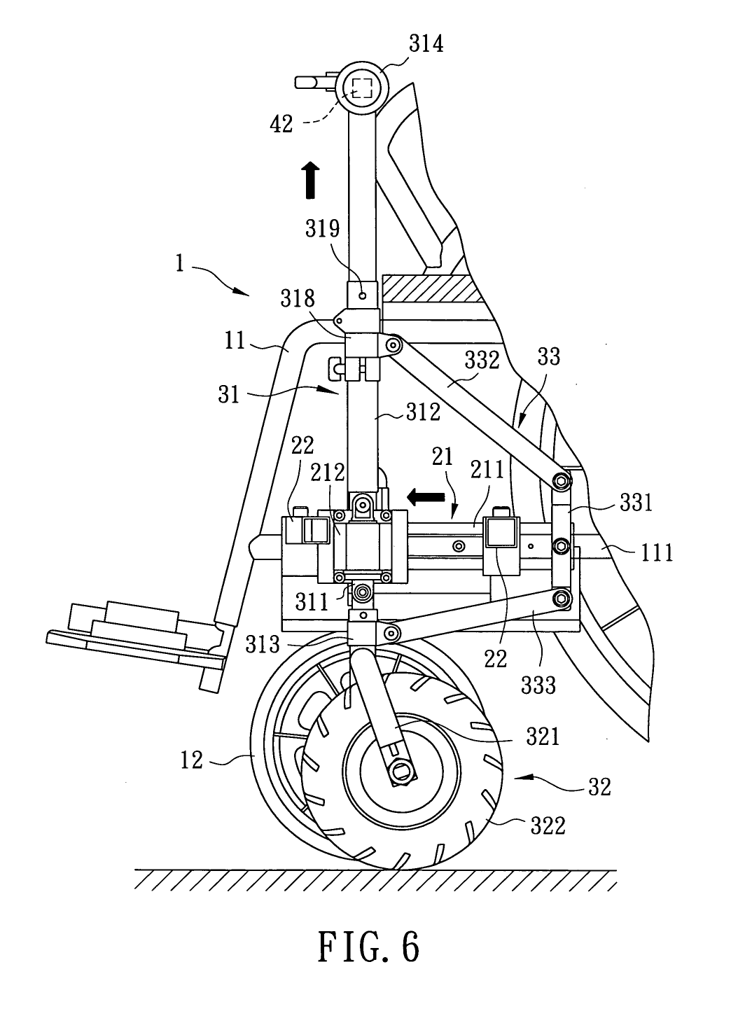

The adjustable unit 3 includes a steering operation rod unit 31 disposed rotatably on the sliding seat 212 of the coupling seat unit 21, an electrical wheel unit 32 disposed on a bottom end of the operation rod unit 31, and a linkage 33. The linkage 33 interconnects the electrical wheel unit 32 and the coupling seat unit 21 such that the electrical wheel unit 32 is movable relative to the operation rod unit 31 between an unused position shown in FIG. 5 and a used position shown in FIG. 6. In the used position, a lower end of the electrical wheel unit 32 is below that of the front wheels 12. In the unused position, the lower end of the electrical wheel unit 32 is above that of the front wheels 12.

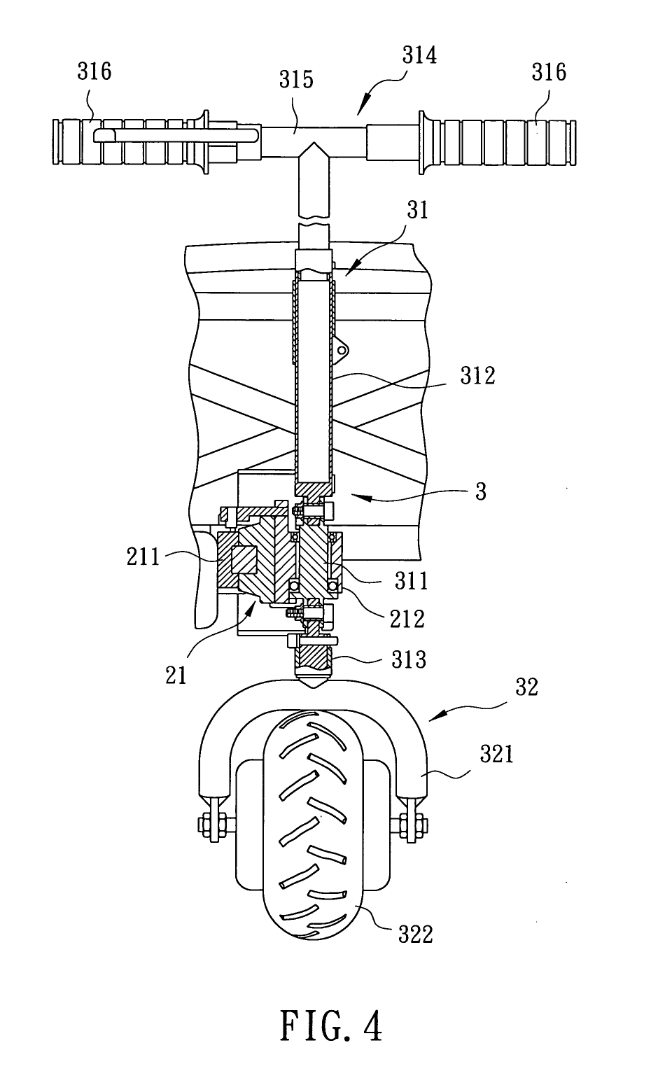

With additional reference to FIG. 4, the operation rod unit 31 includes an upright rod 311, an upper sleeve tube 312, a lower sleeve tube 313, a steering mechanism 314, and a sliding tube 318. The upright rod 311 is journalled on the sliding seat 212 of the coupling seat unit 21. The upper sleeve tube 312 has a lower end connected pivotally to an upper end of the upright rod 311. The lower sleeve tube 313 is sleeved fixedly on an upper end of the electrical wheel unit 32. The sliding tube 318 is sleeved movably on the upper sleeve tube 312.

The steering mechanism 314 includes a T-shaped tube 315 and two grip members 316. The T-shaped tube 315 has a vertical tube portion 315′ disposed telescopically within an upper end of the upper sleeve tube 312, and a horizontal tube portion 315″ formed integrally with the upper end of the vertical tube portion 315′. The vertical tube portion 315′ is formed with two positioning holes (Hi). The upper sleeve tube 312 is formed with a positioning hole (H2). A positioning pin 319 (see FIG. 3) extends through the positioning hole (H2) in the upper sleeve tube 312 and a selected one of the positioning holes (H1) in the vertical tube portion 315′. The positioning pin 319, the positioning holes (H1, H2) in the vertical tube portion 315′, and the upper sleeve tube 312 constitute cooperatively a positioning unit for positioning the T-shaped tube 315 on the upper sleeve tube 312. As such, the steering mechanism 314 is movable relative to the upper sleeve tube 312 between an extended position shown in FIG. 6 and a retracted position shown in FIG. 5. The grip members 316 are sleeved respectively on and foldable respectively on two opposite ends of the horizontal tube portion 315″ of the T-shaped tube 315. In this embodiment, the grip members 316 are sleeved movably on the T-shaped tube 315, and are fastened to the T-shaped tube 315 by two resilient cords 317, respectively. Thus, the grip members 316 can be pulled away from each other so as to allow for folding on the T-shaped tube 315. As a result, the user can conveniently get on and off the wheelchair 1. Alternatively, the steering mechanism 314 may be connected pivotally to the upper sleeve tube 312. In this state, the T-shaped tube 315 may be formed integrally with the grip members 316.

The electrical wheel unit 32 includes an inverted Y-shaped fork 321 and an electrical wheel 322. The fork 321 is connected pivotally to a lower end of the upright rod 311, and is rotatable about a horizontal axis between the positions shown in FIGS. 5 and 6. The electrical wheel 322 is connected rotatably to the fork 321, and is driven electrically by the power supply unit 4. The lower sleeve tube 313 is sleeved fixedly on an upper end of the fork 321.

The linkage 33 includes a swing rod 331, an upper link 332, and a lower link 333. The swing rod 331 is disposed pivotally on the guide rail 211 of the coupling seat unit 21 at an intermediate portion thereof. The upper link 332 has two ends connected respectively and pivotally to the sliding tube 318 of the operation rod unit 31 and an upper end of the swing rod 331. The lower link 333 has two ends connected respectively and pivotally to the lower sleeve tube 313 of the operation rod unit 31 and a lower end of the swing rod 331.

The power supply unit 4 includes a battery 41 for providing electricity to the electrical wheel unit 32, and a controller 42 for controlling the rotation direction of the electrical wheel 322.

Referring to FIG. 5, when the electrical wheel unit 32 is disposed in the unused position, the steering mechanism 314 may be moved to the retracted position. In this position, the user can move the wheelchair 1 manually.

Referring to FIG. 6, when it is desired to move the wheelchair 1 electrically, the steering mechanism 314 is pivoted upwardly, as shown by the arrow of FIG. 5. As a result, the sliding seat 212 moves forwardly along the guide rail 211 to thereby place the operation rod unit 31 in an erect state. Next, the steering mechanism 314 is moved to the extended position.

The electrical wheel unit 32 may be moved between the unused position and the used position in other ways. For example, a driving device may be disposed on the guide rail 211, and connected to the sliding seat 212 for moving the sliding seat 212 on the guide rail 211 between two positions. The driving device may be a hydraulic, pneumatic, electrical, or mechanical device.

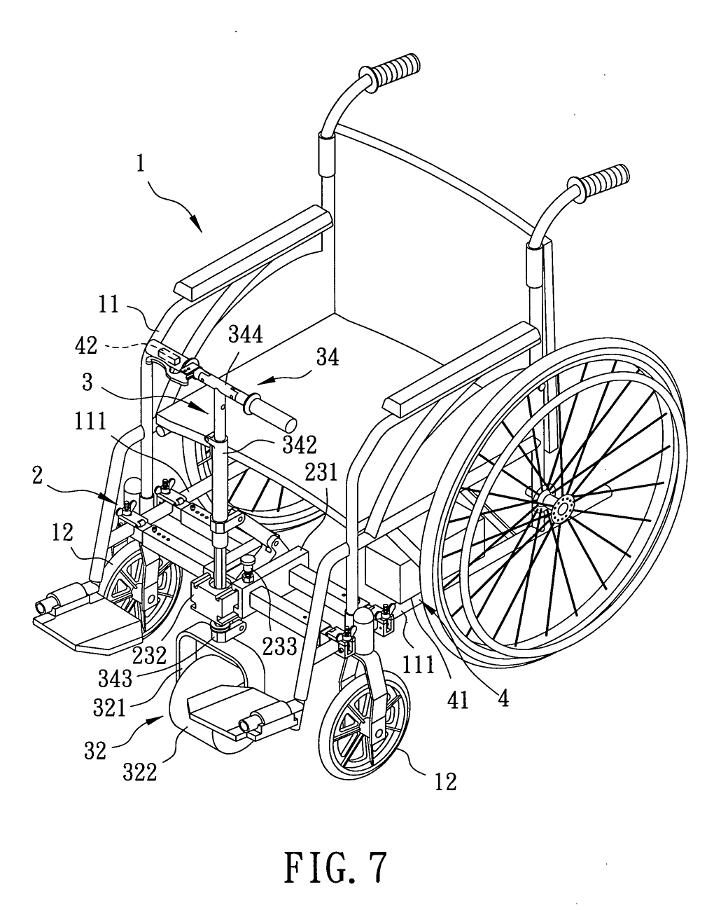

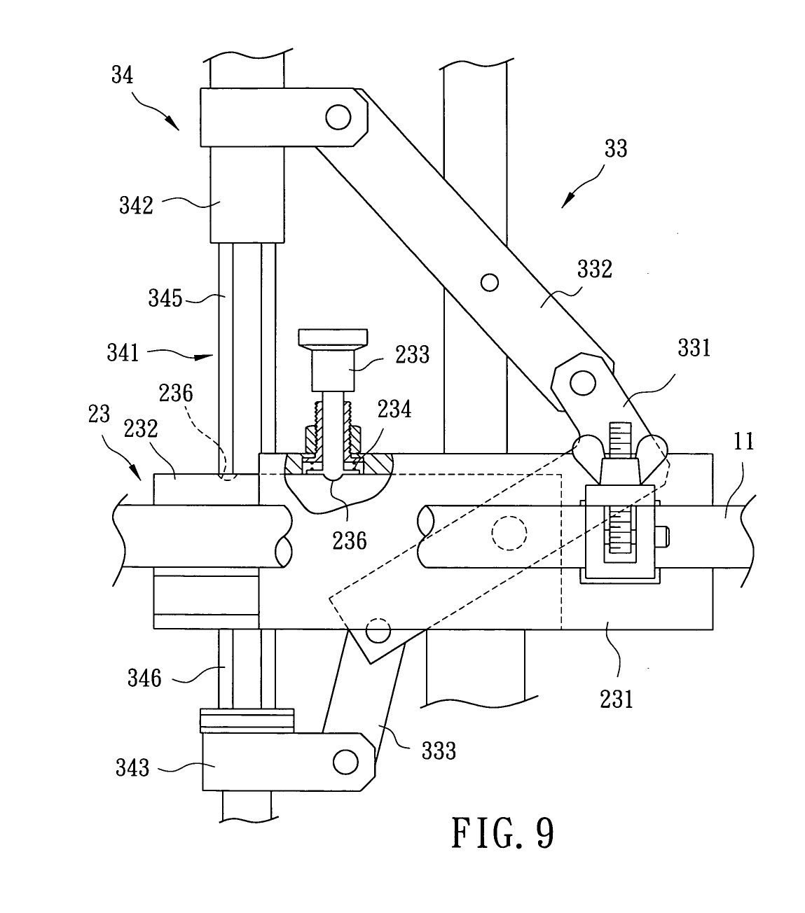

Referring to FIGS. 7 to 9, the second preferred embodiment of an auxiliary power device according to this invention also includes a coupling assembly 2, an adjustable unit 3, and a power supply unit 4. The coupling assembly 2 includes two horizontal rod units 22 and a coupling seat unit 23. The adjustable unit 3 includes a steering operation rod unit 34, an electrical wheel unit 32, and a linkage 33. The horizontal rod units 22, the electrical wheel unit 32, and the power supply unit 4 are similar in construction to those of the first embodiment.

The coupling seat unit 23 includes two mounting seats 231, a sliding block 232, a positioning pin 233, and a resilient member 234. The mounting seats 231 are attached respectively to the telescopic tube members 22′. Each of the mounting seats 231 is formed with a guide slot 235. The horizontal rod units 22 are located to two sides of an assembly of the mounting seats 231. Each of the horizontal rod units 22 includes two outer tubes 221 that are connected respectively and fixedly to the mounting seats 231. The sliding block 232 is disposed movably between the mounting seats 231, and is movable along the guide slots 235 in the mounting seats 231. The positioning pin 233 is disposed movably on one of the mounting seats 231. The resilient member 234 biases the positioning pin 233 to move downwardly so as to engage a selected one of front and rear positioning holes 236 in a top surface of the sliding block 232, thereby positioning the sliding block 232 between the mounting seats 231.

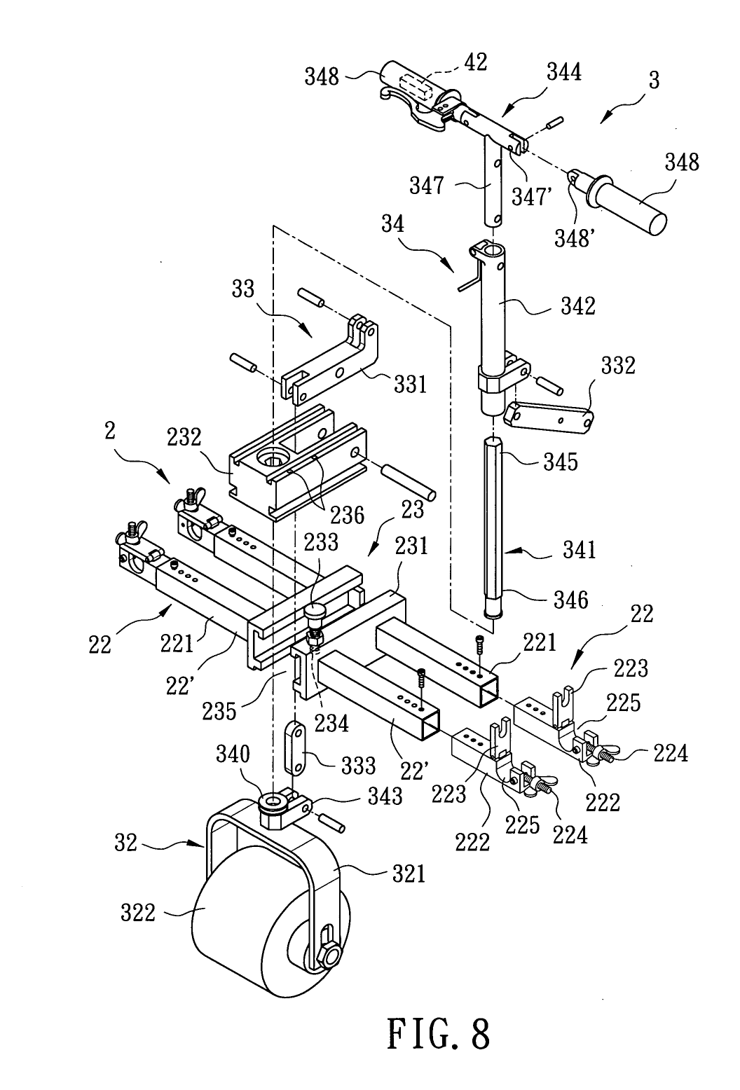

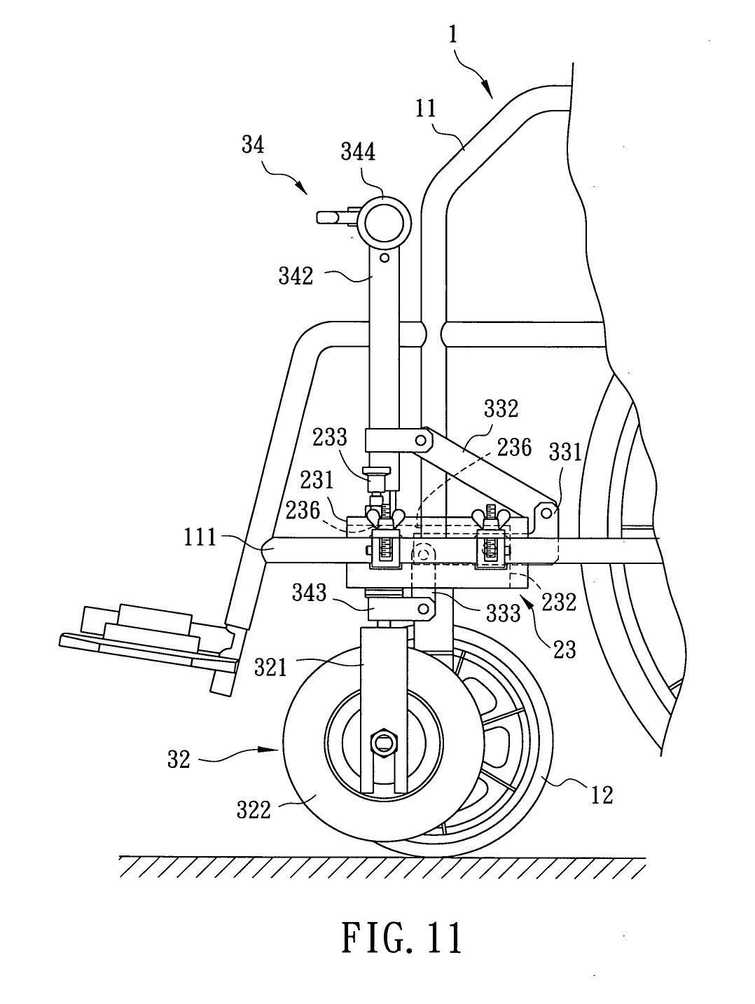

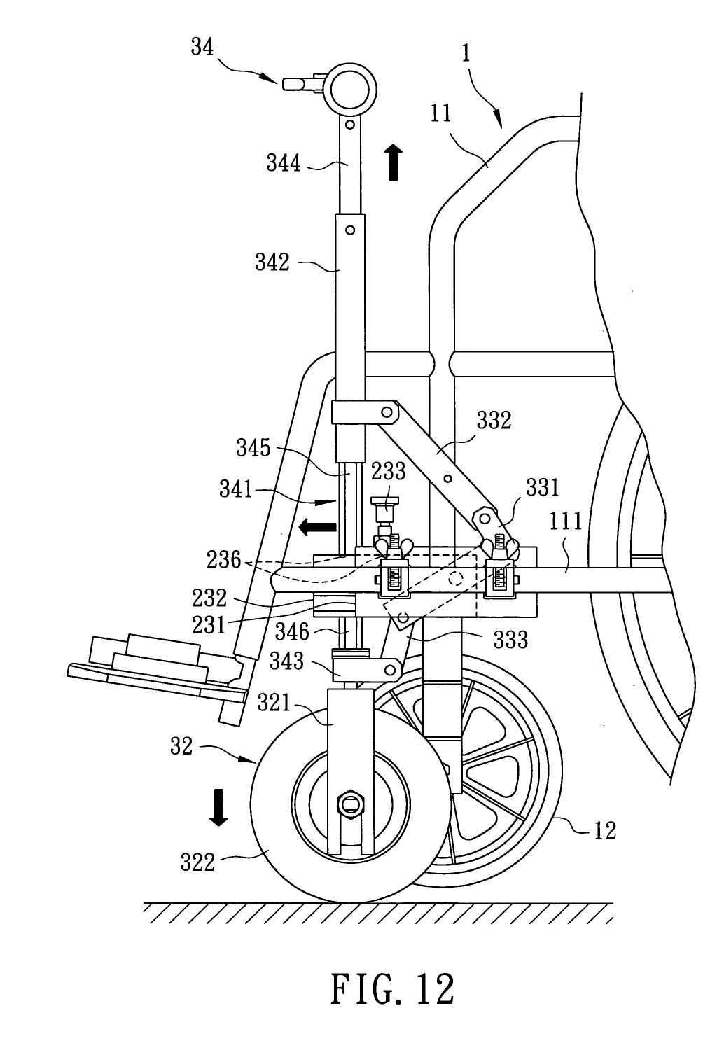

The operation rod unit 34 includes an upright rod 341, an upper sleeve tube 342, a lower sleeve tube 343, and a steering mechanism 344. The upright rod 341 is journalled on the sliding block 232, and has upper and lower ends 345, 346 disposed outwardly of the sliding block 232. The upper sleeve tube 342 is sleeved movably on the upper end 345 of the upright rod 341. The lower sleeve tube 343 is sleeved rotatably on the lower end 346 of the upright rod 341 by a bearing 340 (see FIG. 8). The steering mechanism 344 is disposed telescopically within an upper end of the upper sleeve tube 342, and is movable between an extended position shown in FIG. 12 and a retracted position shown in FIG. 11. The steering mechanism 344 is positioned relative to the upper sleeve tube 342 by a positioning unit that is similar in construction to that of the first embodiment. The steering mechanism 344 includes a T-shaped tube 347 connected telescopically to the upper sleeve tube 342, and two grip members 348 connected pivotally to and located to two sides of the T-shaped tube 347. The T-shaped tube 347 is formed with two positioning holes 347′ (only one is shown in FIG. 8). Each of the grip members 348 is provided with a spring-biased ball 348′. The balls 348′ are biased to engage respectively the positioning holes 347′ in the T-shaped tube 347 so as to maintain each of the grip members 348 in a horizontal position. The balls 348′ are removable respectively and forcibly from the positioning holes 347′. This allows the grip members 348 to be folded on the T-shaped tube 347.

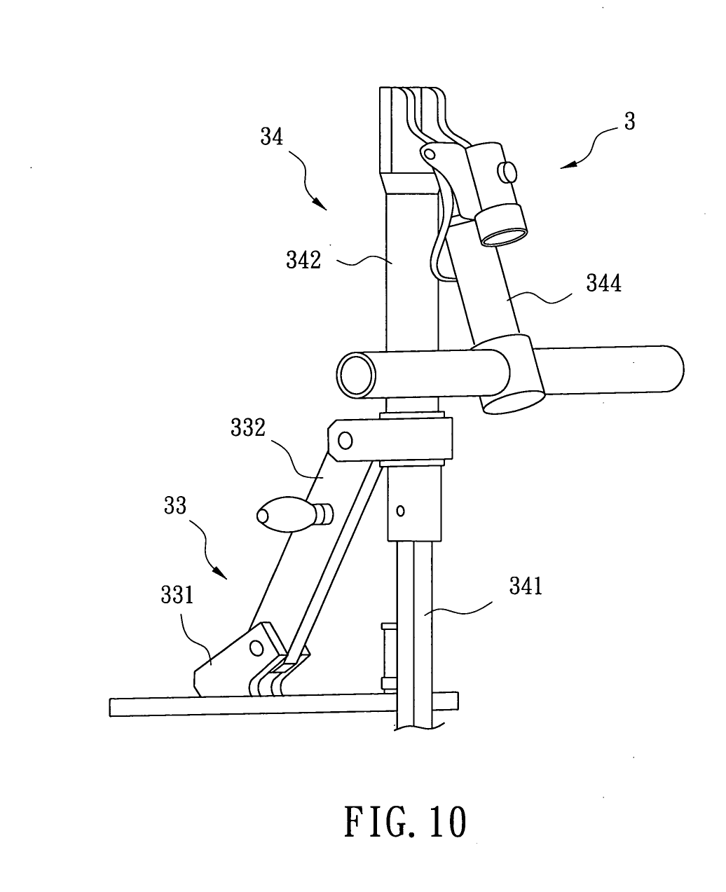

FIG. 10 shows a modified steering mechanism 344 that is connected pivotally to an upper end of the upper sleeve 342 and that is rotatable about a horizontal axis. As such, the steering mechanism 344 can be pivoted downwardly to thereby reduce the height of the operation rod unit 34 so as to allow the user to conveniently get on and off the wheelchair.

The fork 321 of the electrical wheel unit 32 is connected fixedly to a lower end of the lower sleeve tube 343. The upright rod 341 has a hexagonal cross section, and engages fittingly a hexagonal hole (not shown) in the fork 321 so as to co-rotate with the fork 321.

The linkage 33 includes a swing rod 331, an upper link 332, and a lower link 333. The swing rod 331 is connected pivotally to the sliding block 232 of the coupling seat unit 23 at an intermediate portion thereof. The upper link 332 has two ends connected respectively and pivotally to the upper sleeve tube 342 of the operation rod unit 34 and an upper end of the swing rod 331. The lower link 333 has two ends connected respectively and pivotally to the lower sleeve tube 343 of the operation rod unit 34 and a lower end of the swing rod 331. Due to the presence of the linkage 33, the upper and lower sleeve tubes 342, 343 move in opposite directions. Thus, the electrical wheel unit 32 is movable between an unused position shown in FIG. 11 and a used position shown in FIG. 12. In the used position, a lower end of the electrical wheel unit 32 is below that of the front wheels 12. In the unused position, the lower end of the electrical wheel unit 32 is above that of the front wheels 12.

With further reference to FIG. 11, when the electrical wheel unit 32 is disposed in the unused position, the positioning pin 233 engages the front positioning hole 236. The steering mechanism 344 may then be moved to the retracted position, and the user can move the wheelchair 1 manually.

Referring to FIG. 12, when it is desired to move the wheelchair 1 electrically, the positioning pin 233 is removed upwardly from the front positioning hole 236. Subsequently, the sliding block 232 is moved forwardly until the positioning pin 233 engages the rear positioning hole 236, and the steering mechanism 344 is moved to the extended position. When the positioning pin 233 engages the rear positioning hole 236, the electrical wheel unit 32 is moved to the used position by the linkage 33.

When it is desired to return the electrical wheel unit 32 to the unused position, it is only necessary to remove the positioning pin 233 from the rear positioning hole 236 and move the steering mechanism 344 downwardly.

A hydraulic, pneumatic, or mechanical driving device also may be provided for moving the sliding block 232.

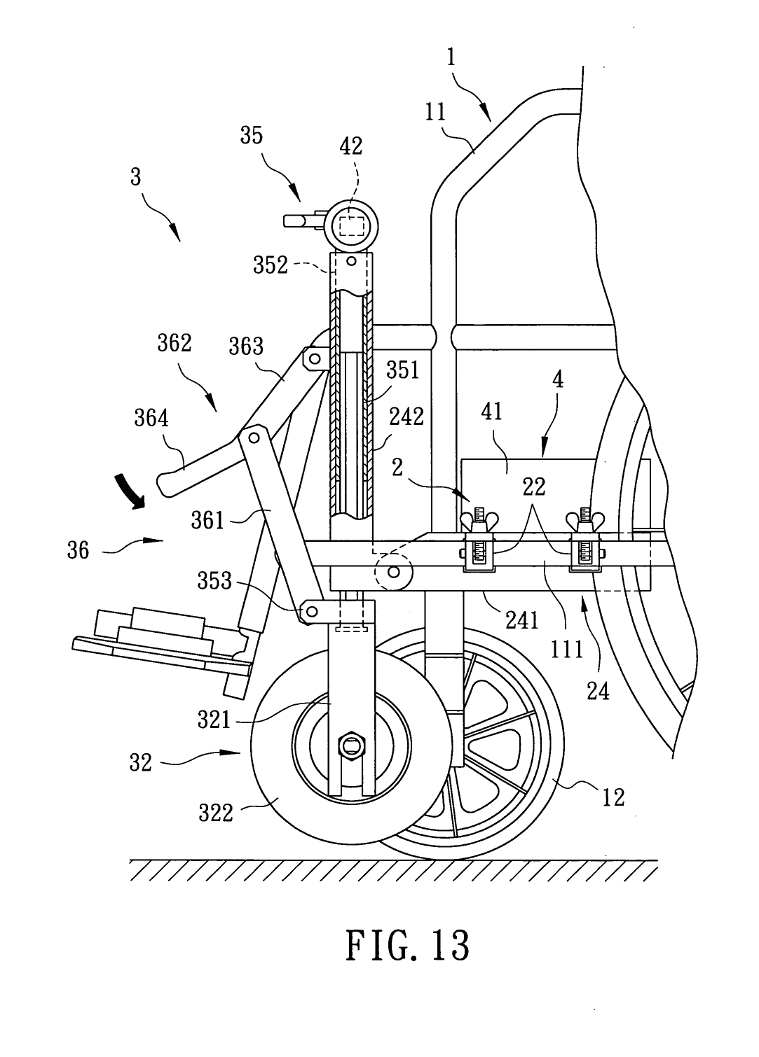

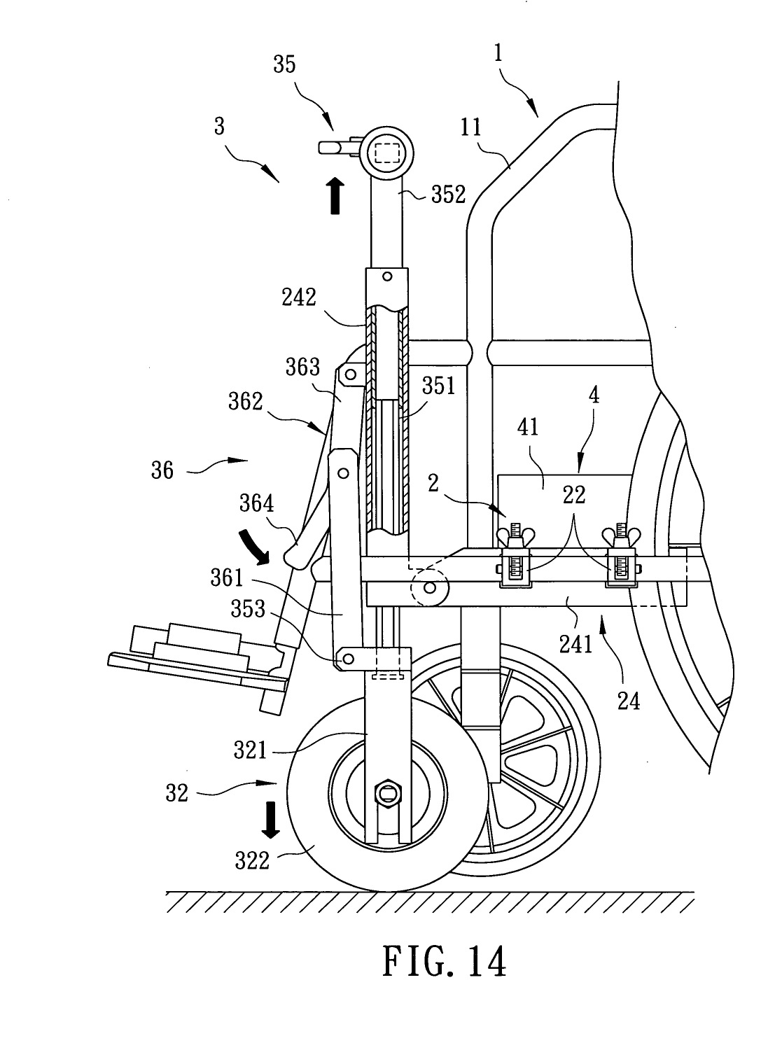

Referring to FIGS. 13 and 14, the third preferred embodiment of an auxiliary power device according to this invention also includes a coupling assembly 2, an adjustable unit 3, and a power supply unit 4. The coupling assembly 2 includes two horizontal rod units 22 and a coupling seat unit 24. The adjustable unit 3 includes a steering operation rod unit 35, an electrical wheel unit 32, and a linkage 36. The horizontal rod units 22, the electrical wheel unit 32, and the power supply unit 4 are also similar in construction to those of the first embodiment.

The coupling seat unit 24 includes a mounting seat 241 connected fixedly to the horizontal rod units 22, and an upright coupling tube 242 disposed fixedly on a front end of the mounting seat 241 and permitting the operation rod unit 35 to extend thereinto. The horizontal rod units 22 are connected fixedly to the mounting seat 241. The operation rod unit 35 includes an upright rod 351, a steering mechanism 352, and a lower sleeve tube 353. The upright rod 351 is disposed rotatably within the coupling tube 242 of the coupling seat unit 24. The steering mechanism 352 is disposed telescopically within an upper end of the coupling tube 242, and is sleeved movably on an upper end of the upright rod 351. The steering mechanism 352 is positioned relative to the coupling tube 242 by a positioning unit that is similar in construction to that of the first embodiment. The lower sleeve tube 353 is sleeved rotatably on a lower end of the upright rod 351 by a bearing (not shown).

The electrical wheel unit 32 includes a fork 321 connected fixedly to a lower end of the upright rod 351 of the operation rod unit 35, and an electrical wheel 322 connected rotatably to the fork 321 and driven electrically by the power supply unit 4.

The linkage 36 includes a lower link 361 having a lower end connected pivotally to the lower sleeve tube 353, and an upper link 362 having a connecting portion 363 and an operation portion 364. The connecting portion 363 has an upper end connected pivotally to the coupling tube 242 of the coupling seat unit 24, and a lower end connected pivotally to an upper end of the lower link 361. The operation portion 364 extends forwardly and downwardly from the lower end of the connecting portion 363, and permits manual operation by the user.

The upper link 362 is pivotable upwardly so as to move the electrical wheel unit 32 to an unused position shown in FIG. 13, and is pivotable downwardly so as to move the electrical wheel unit 32 to a used position shown in FIG. 14.

The auxiliary power device of this invention has the following advantages:

1. The auxiliary power device is easy to operate. The electrical wheel unit 32 can be moved toward and away from the ground by simply moving the steering mechanism 314, 344 and by pivoting the operation portion 364.

2. The auxiliary power device allows the user to get conveniently get on and off the wheelchair 1. When the user gets on and off the wheelchair 1, the steering mechanisms 314, 344 can be retracted or folded so as not to impede movement of the legs of the user.

3. The auxiliary power device is compact. The volume of the auxiliary power device is smaller than that of the abovementioned prior art. Furthermore, the steering mechanism 314, 344 can be folded or retracted so as to reduce the volume of the auxiliary power device.

4. The auxiliary power device is easy to assemble and disassemble. The auxiliary power device can be assembled to and disassembled from the wheelchair 1 by simply operating only the retaining members 223 and the locking members 224.

With this invention thus explained, it is apparent that numerous modifications and variations can be made without departing from the scope and spirit of this invention. It is therefore intended that this invention be limited only as indicated by the appended claims.

I claim:

1. An auxiliary power device for a wheelchair, the wheelchair including a chair frame, and two spaced-apart front wheels disposed pivotally on a bottom portion of a front end of the chair frame, said auxiliary power device comprising:
a coupling assembly including a coupling seat unit adapted to be disposed on the chair frame;
an adjustable unit including
a steering operation rod unit disposed rotatably on said coupling seat unit of said coupling assembly,
an electrical wheel unit disposed on a bottom end of said operation rod unit, and
a linkage interconnecting said electrical wheel unit and said coupling seat unit such that said electrical wheel unit is movable relative to said operation rod unit between a used position whereat a lower end of said electrical wheel unit is below that of the front wheels, and an unused position whereat said lower end of said electrical wheel unit is above that of the front wheels; and
a power supply unit including a battery for providing electricity to said electrical wheel unit, and a controller for controlling the rotational direction of said electrical wheel unit.

2. The auxiliary power device as claimed in claim 1, wherein
said coupling assembly further includes two horizontal rod units connected respectively and fixedly to front and rear sides of said chair frame; and
said coupling seat unit includes
a guide rail disposed between said horizontal rod units and having front and rear ends connected respectively and fixedly to said horizontal rod units, and
a sliding seat movable along said guide rail.

3. The auxiliary power device as claimed in claim 2, wherein said operation rod unit includes:
an upright rod journalled on said sliding seat of said coupling seat unit of said coupling assembly;
an upper sleeve tube having a lower end connected pivotally to an upper end of said upright rod; and
a steering mechanism disposed telescopically within an upper end of said upper sleeve tube.

4. The auxiliary power device as claimed in claim 3, wherein said electrical wheel unit includes:
a fork attached to and rotatable relative to a lower end of said upright rod of said operation rod unit about a horizontal axis; and
an electrical wheel connected rotatably to said fork and driven electrically by said power supply unit.

5. The auxiliary power device as claimed in claim 4, wherein
said operation rod unit further includes a lower sleeve tube sleeved fixedly on an upper end of said fork, and a sliding tube sleeved movably on said upper sleeve tube; and
said linkage includes
a swing rod disposed pivotally on said guide rail of said coupling assembly at an intermediate portion thereof and having upper and lower ends,
an upper link having two ends connected respectively and pivotally to said sliding tube of said operation rod unit and said upper end of said swing rod, and
a lower link having two ends connected respectively and pivotally to said lower sleeve tube of said operation rod unit and said lower end of said swing rod.

6. The auxiliary power device as claimed in claim 5, the chair frame having a pair of left and right side rods each having a front end, the front wheels being disposed respectively and pivotally on front ends of the left and right side rods, wherein each of said horizontal rod units includes a pair of telescopic tube members located respectively to two sides of an assembly of said mounting seats, each of said telescopic tube members including:
an outer tube having an inner end connected fixedly to a corresponding one of said mounting seats, and an outer end opposite to said inner end;
an inner tube disposed telescopically within said outer end of said outer tube and having a top surface formed with a slot that has open front and rear ends and that is adapted to receive a corresponding one of the left and right side rods of the chair frame therein;
a retaining member disposed pivotally on said inner tube and immediately above said slot in said inner tube so as to confine the corresponding one of the left and right side rods between said inner tube and said retaining member; and
a locking member disposed pivotally on said inner tube and connected to said retaining member so as to lock said retaining member on said inner tube.

7. The auxiliary power device as claimed in claim 6, wherein said steering mechanism of said operation rod unit includes:
a T-shaped tube having a vertical tube portion disposed telescopically within said upper sleeve tube, and a horizontal tube portion formed integrally with an upper end of said vertical tube portion; and
two grip members sleeved respectively on and foldable respectively on two opposite ends of said horizontal tube portion of said T-shaped tube.

8. The auxiliary power device as claimed in claim 3, wherein said steering mechanism of said operation rod unit includes:
a T-shaped tube having a vertical tube portion disposed telescopically within said upper sleeve tube, and a horizontal tube portion formed integrally with an upper end of said vertical tube portion; and
two grip members sleeved respectively on and foldable respectively on two opposite ends of said horizontal tube portion of said T-shaped tube.

9. The auxiliary power device as claimed in claim 1, wherein
each of said horizontal rod units includes a pair of telescopic tube members located respectively to two sides of said guide rail; and
said coupling seat unit of said coupling assembly includes:
two mounting seats attached respectively to said telescopic tube members, each of said mounting seats being formed with a guide slot, and
a sliding block disposed movably between said mounting seats and movable along said guide slots in said mounting seats, said operation rod unit being journalled on said sliding block.

10. The auxiliary power device as claimed in claim 9, wherein said operation rod unit of said adjustable unit includes:
an upright rod journalled on said sliding block and having upper and lower ends disposed outwardly of said sliding block;
an upper sleeve tube sleeved movably on said upper end of said upright rod;
a lower sleeve tube sleeved rotatably on said lower end of said upright rod; and
a steering mechanism disposed telescopically within an upper end of said upper sleeve tube.

11. The auxiliary power device as claimed in claim 9, wherein said operation rod unit of said adjustable unit includes:
an upright rod journalled on said sliding block and having upper and lower ends disposed outwardly of said sliding block;
an upper sleeve tube sleeved movably on said upper end of said upright rod;
a lower sleeve tube sleeved rotatably on said lower end of said upright rod; and
a steering mechanism connected pivotally to and rotatable relative to an upper end of said upper sleeve tube and rotatable about a horizontal axis.

12. The auxiliary power device as claimed in claim 10, wherein said electrical wheel unit includes:
a fork connected fixedly to a lower end of said lower sleeve tube; and
an electrical wheel connected rotatably to said fork and driven electrically by said power supply unit.

13. The auxiliary power device as claimed in claim 12, wherein said linkage includes:
a swing rod disposed pivotally on said sliding block of said coupling seat unit at an intermediate portion thereof and having upper and lower ends,
an upper link having two ends connected respectively and pivotally to said upper sleeve tube of said operation rod unit and said upper end of said swing rod, and
a lower link having two ends connected respectively and pivotally to said lower sleeve tube of said operation rod unit and said lower end of said swing rod.

14. The auxiliary power device as claimed in claim 13, the chair frame having a pair of left and right side rods each having a front end, the front wheels being disposed respectively and pivotally on front ends of the left and right side rods, wherein each of said horizontal rod units includes a pair of telescopic tube members located respectively to two sides of said guide rail, each of said telescopic tube members including:
an outer tube having an inner end connected fixedly to said guide rail, and an outer end opposite to said inner end;
an inner tube disposed telescopically within said outer end of said outer tube and having a top surface formed with a slot that has open front and rear ends and that is adapted to receive a corresponding one of the left and right side rods of the chair frame therein;
a retaining member disposed pivotally on said inner tube and immediately above said slot in said inner tube so as to confine the corresponding one of the left and right side rods between said inner tube and said retaining member; and
a locking member disposed pivotally on said inner tube and connected to said retaining member so as to lock said retaining member on said inner tube.

15. The auxiliary power device as claimed in claim 14, wherein
said sliding block has a top surface formed with two positioning holes; and
said coupling seat unit of said coupling assembly further includes a positioning pin disposed movably on one of said mounting seats, and a resilient member for biasing said positioning pin to engage a selected one of said positioning holes in said sliding block so as to position said sliding block between said mounting seats.

16. The auxiliary power device as claimed in claim 11, wherein said electrical wheel unit includes:
a fork connected fixedly to a lower end of said lower sleeve tube; and
an electrical wheel connected rotatably to said fork and driven electrically by said power supply unit.

17. The auxiliary power device as claimed in claim 16, wherein said linkage includes:
a swing rod disposed pivotally on said sliding block of said coupling seat unit at an intermediate portion thereof and having upper and lower ends,
an upper link having two ends connected respectively and pivotally to said upper sleeve tube of said operation rod unit and said upper end of said swing rod, and
a lower link having two ends connected respectively and pivotally to said lower sleeve tube of said operation rod unit and said lower end of said swing rod.

18. The auxiliary power device as claimed in claim 17, the chair frame having a pair of left and right side rods each having a front end, the front wheels being disposed respectively and pivotally on front ends of the left and right side rods, wherein each of said horizontal rod units includes a pair of telescopic tube members located respectively to two sides of an assembly of said mounting seats, each of said telescopic tube members including:
an outer tube having an inner end connected fixedly to a corresponding one of said mounting seats, and an outer end opposite to said inner end;
an inner tube disposed telescopically within said outer end of said outer tube and having a top surface formed with a slot that has open front and rear ends and that is adapted to receive a corresponding one of the left and right side rods of the chair frame therein;
a retaining member disposed pivotally on said inner tube and immediately above said slot in said inner tube so as to confine the corresponding one of the left and right side rods between said inner tube and said retaining member; and
a locking member disposed pivotally on said inner tube and connected to said retaining member so as to lock said retaining member on said inner tube.

19. The auxiliary power device as claimed in claim 18, wherein
said sliding block has a top surface formed with two positioning holes; and
said coupling seat unit of said coupling assembly further includes a positioning pin disposed movably on one of said mounting seats, and a resilient member for biasing said positioning pin to engage a selected one of said positioning holes in said sliding block so as to position said sliding block between said mounting seats.

20. The auxiliary power device as claimed in claim 10, wherein said steering mechanism of said operation rod unit includes:
a T-shaped tube having a vertical tube portion disposed telescopically within said upper sleeve tube, and a horizontal tube portion formed integrally with an upper end of said vertical tube portion; and
two grip members sleeved respectively on and foldable respectively on two opposite ends of said horizontal tube portion of said T-shaped tube.

21. The auxiliary power device as claimed in claim 11, wherein said steering mechanism of said operation rod unit includes:
a T-shaped tube having a vertical tube portion disposed telescopically within said upper sleeve tube, and a horizontal tube portion formed integrally with an upper end of said vertical tube portion; and
two grip members sleeved respectively on and foldable respectively on two opposite ends of said horizontal tube portion of said T-shaped tube.

22. The auxiliary power device as claimed in claim 1, wherein said coupling seat unit of said coupling assembly includes a mounting seat connected fixedly to said horizontal rod units, and an upright coupling tube disposed fixedly on a front end of said mounting seat and permitting said operation rod unit to extend thereinto.

23. The auxiliary power device as claimed in claim 22, wherein said operation rod unit of said adjustable unit includes:
an upright rod disposed rotatably within said coupling tube of said coupling seat unit;
a steering mechanism disposed telescopically within an upper end of said coupling tube and sleeved movably on an upper end of said upright rod; and
a lower sleeve tube sleeved rotatably on a lower end of said upright rod.

24. The auxiliary power device as claimed in claim 23, wherein said electrical wheel unit includes:
a fork connected fixedly to a lower end of said upright rod of said operation rod unit; and
an electrical wheel connected rotatably to said fork and driven electrically by said power supply unit.

25. The auxiliary power device as claimed in claim 24, wherein said linkage includes:
a lower link having an upper end and a lower end that is connected pivotally to said lower sleeve tube; and
an upper link having a connecting portion and an operation portion, said connecting portion having an upper end connected pivotally to said coupling tube of said coupling seat unit of said coupling seat unit, and a lower end connected pivotally to said upper end of said lower link, said operation portion extending forwardly and downwardly from said lower end of said connecting portion and adapted to permit manual operation by a user.

26. The auxiliary power device as claimed in claim 25, the chair frame having a pair of left and right side rods each having a front end, the front wheels being disposed respectively and pivotally on front ends of the left and right side rods, wherein each of said horizontal rod units includes a pair of telescopic tube members located respectively to two sides of said guide rail, each of said telescopic tube members including:
an outer tube having an inner end connected fixedly to said mounting seat, and an outer end opposite to said inner end;
an inner tube disposed telescopically within said outer end of said outer tube and having a top surface formed with a slot that has open front and rear ends and that is adapted to receive a corresponding one of the left and right side rods of the chair frame therein;
a retaining member disposed pivotally on said inner tube and immediately above said slot in said inner tube so as to confine the corresponding one of the left and right side rods between said inner tube and said retaining member; and
a locking member disposed pivotally on said inner tube and connected to said retaining member so as to lock said retaining member on said inner tube.
